(19) United States
(12) Patent Application Publication
(10) Pub. No.: US 2007/0018759 A1
(43) Pub. Date: Jan. 25, 2007

(54) Switch

(75) Inventor: Chia Hsiang Chiu, Taipei (TW)

Correspondence Address: QUINTERO LAW OFFICE, 1617 BROADWAY, 3RD FLOOR, SANTA MONICA, CA, 90404, US

(73) Assignee: LITE-ON TECHNOLOGY CORPORATION, TAIPEI (TW)

(21) Appl. No.: 11/240,307

(22) Filed: Sep. 29, 2005

(30) Foreign Application Priority Data
Jul. 22, 2005 (TW) TW94124935

(51) Int. Cl. H01H 51/22

(52) U.S. Cl. 335/78

(57) ABSTRACT

A switch. A lid body is rotatably connected to a casing and includes a first magnetic portion. A polarity-switching mechanism is disposed in the casing and separated from the first magnetic portion. The lid body rotates to a first position by attraction between the polarity-switching mechanism and the first magnetic portion when the polarity of the polarity-switching mechanism differs from that of the first magnetic portion. The lid body rotates to a second position by repulsion between the polarity-switching mechanism and the first magnetic portion when the polarity of the polarity-switching mechanism is the same as that of the first magnetic portion.

### BACKGROUND

The invention relates to switches, and in particular to switches applying magnetic attraction and repulsion.

In a conventional electronic device, opening and closing of a lid is often achieved by springs or motors in combination with multiple gears. The springs, however, can provide only automatic opening. Manual operation is required when the lid is closed. In addition, although motors and gears can provide automatic opening and closing of the lid, electricity is still required. Also, motors and gears increase complexity of design and manufacture as well.

Hence, there is a need for simplified switches, by means of which convenient opening and closing of lids can be achieved.

### SUMMARY

Accordingly, an embodiment of the invention provides a switch comprising a casing, a lid body, and a polarity-switching mechanism. The lid body is rotatably connected to the casing and comprises a first magnetic portion. The polarity-switching mechanism is disposed in the casing and separated from the first magnetic portion. The lid body rotates to a first position by attraction between the polarity-switching mechanism and the first magnetic portion when the polarity of the polarity-switching mechanism differs from that of the first magnetic portion. The lid body rotates to a second position by repulsion between the polarity-switching mechanism and the first magnetic portion when the polarity of the polarity-switching mechanism is the same as that of the first magnetic portion.

The polarity-switching mechanism is slidably disposed in the casing and comprises a second magnetic portion and a third magnetic portion separated therefrom by a predetermined distance. The polarity of the second magnetic portion differs from that of the first magnetic portion. The polarity of the third magnetic portion is the same as that of the first magnetic portion. The lid body rotates to the first position by attraction between the first and second magnetic portions when the polarity-switching mechanism slides to allow the second magnetic portion to face the first magnetic portion. The lid body rotates to the second position by repulsion between the first and third magnetic portions when the polarity-switching mechanism slides to allow the third magnetic portion to face the first magnetic portion.

The switch further comprises a latch disposed in the casing. The polarity-switching mechanism is positioned in the latch when the polarity-switching mechanism slides to allow the third magnetic portion to face the first magnetic portion. The polarity-switching mechanism is separated from the latch when the polarity-switching mechanism slides to allow the second magnetic portion to face the first magnetic portion.

The polarity-switching mechanism further comprises a sliding shaft and a push portion. The second and third magnetic portions are disposed on the sliding shaft. The push portion is connected to the sliding shaft. The polarity-switching mechanism is positioned in the latch by way of the sliding shaft.

The first magnetic portion is a magnet.

The first magnetic portion is a coil capable of providing polarity when applied with an electric current.

The second and third magnetic portions are magnets.

The polarity-switching mechanism is rotatably disposed in the casing and comprises a second magnetic portion and a third magnetic portion opposite thereto. The polarity of the second magnetic portion differs from that of the first magnetic portion. The polarity of the third magnetic portion is the same as that of the first magnetic portion. The lid body rotates to the first position by attraction between the first and second magnetic portions when the polarity-switching mechanism rotates to allow the second magnetic portion to face the first magnetic portion. The lid body rotates to the second position by repulsion between the first and third magnetic portions when the polarity-switching mechanism rotates to allow the third magnetic portion to face the first magnetic portion.

The switch further comprises a sliding shaft and a push portion connected thereto. The sliding shaft is connected to the polarity-switching mechanism and slidably disposed in the casing. The polarity-switching mechanism rotates by sliding of the sliding shaft, allowing the second or third magnetic portion to face the first magnetic portion.

The switch further comprises a latch disposed in the casing. The sliding shaft is positioned in the latch when sliding to allow the third magnetic portion of the polarity-switching mechanism to face the first magnetic portion. The sliding shaft is separated from the latch when sliding to allow the second magnetic portion of the polarity-switching mechanism to face the first magnetic portion.

The switch further comprises a guide member and a guide bar. The guide member is fixed to the polarity-switching mechanism. The guide bar is connected to the sliding shaft and slides in the guide member. The polarity-switching mechanism rotates by the guide bar sliding in the guide member.

The polarity-switching mechanism is a magnet, with the second and third magnetic portions being two opposite poles thereof.

The casing further comprises a hinge on which the lid body pivots.

The lid body tightly pivots on the hinge.

### DESCRIPTION OF THE DRAWINGS

The invention can be more fully understood by reading the subsequent detailed description and examples with references made to the accompanying drawings, wherein:

FIG. 1A is a schematic view showing structure and operation of the switch of a first embodiment of the invention;

FIG. 1B is another schematic view showing structure and operation of the switch of a first embodiment of the invention;

FIG. 2A is a schematic view showing structure and operation of the switch of a second embodiment of the invention; and

FIG. 2B is another schematic view showing structure and operation of the switch of a second embodiment of the invention.

### DETAILED DESCRIPTION

The switches of the present invention can be applied in various machines or electronic devices capable of providing opening and closing of lids. In the following exemplary embodiments, explanation is made by applying the switches in optical disk drives.

### First Embodiment

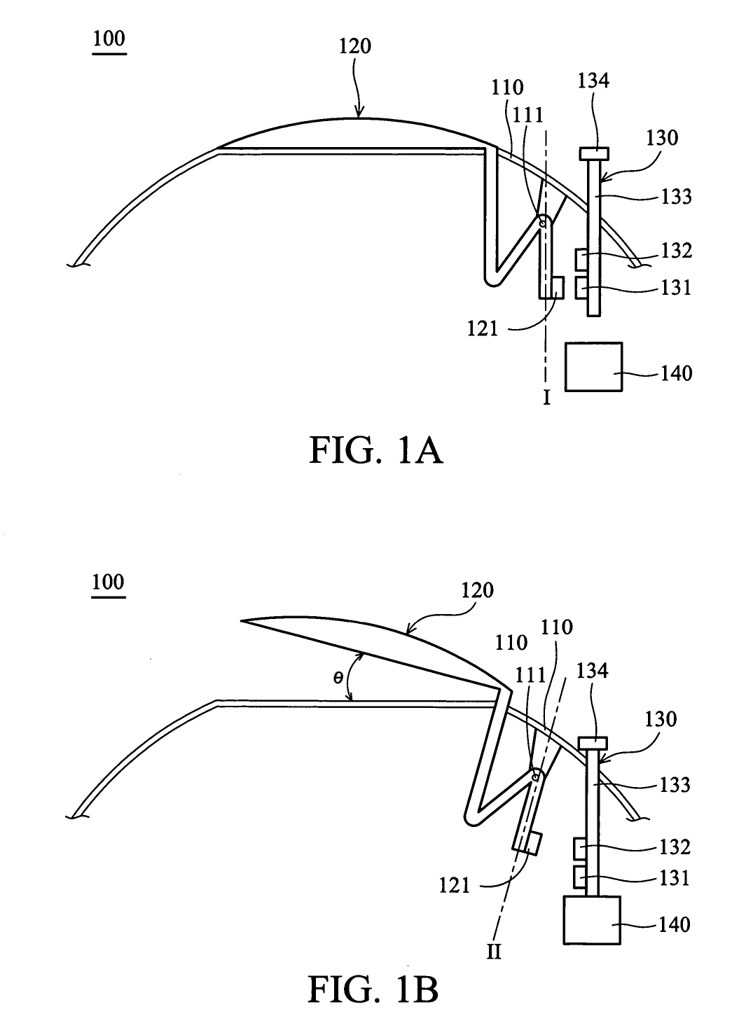

Referring to FIG. 1A and FIG. 1B, the switch 100 comprises a casing 110, a lid body 120, a polarity-switching mechanism 130, and a latch 140.

The casing 110 can be a housing of an optical disk drive and comprises a pivot 111.

The lid body 120 is rotatably connected to the casing 110 and comprises a first magnetic portion 121. The lid body 120 can be a lid of the optical disk drive. Specifically, the lid body 120 pivots on the hinge 111 of the casing 110, such that the lid body 120 can rotate with respect to the casing 110.

The polarity-switching mechanism 130 is slidably disposed in the casing 110 and separated from the first magnetic portion 121 of the lid body 120. The polarity-switching mechanism 130 further comprises a second magnetic portion 131, a third magnetic portion 132, a sliding shaft 133, and a push portion 134. The second magnetic portion 131 and third magnetic portion 132 are disposed on the sliding shaft 133. The second magnetic portion 131 is separated from the third magnetic portion 132 by a predetermined distance. Specifically, the polarity of the second magnetic portion 131 differs from that of the first magnetic portion 121 of the lid body 120, and the polarity of the third magnetic portion 132 is the same as that of the first magnetic portion 121. The push portion 134 is connected to the sliding shaft 133 and serves to activate the polarity-switching mechanism 130.

The latch 140 is disposed in the casing 110 and may comprise springs. The latch 140 can be provided with a conventional structure.

The following description is directed to operation of the switch 100 (or opening and closing of the lid of the optical disk drive).

When the polarity-switching mechanism 130 slides to allow the second magnetic portion 131 thereof to face the first magnetic portion 121 of the lid body 120, the lid body 120 rotates to a first position I by attraction between the second magnetic portion 131 and the first magnetic portion 121 (as the polarity of the second magnetic portion 131 differs from that of the first magnetic portion 121), as shown in FIG. 1A. At this point, the lid body 120 abuts the casing 110. Namely, the lid of the optical disk drive is closed.

The polarity-switching mechanism 130 can slide downward when the push portion 134 is activated. When the third magnetic portion 132 of the polarity-switching mechanism 130 faces the first magnetic portion 121 of the lid body 120, the lid body 120 rotates to a second position II by repulsion between the third magnetic portion 132 and the first magnetic portion 121 (as the polarity of the third magnetic portion 132 is the same as that of the first magnetic portion 121), as shown in FIG. 1B. At this point, the lid body 120 separates from the casing 110. Namely, the lid of the optical disk drive is opened. Additionally, the polarity-switching mechanism 130 can be positioned in the latch 140 by the sliding shaft 133.

The push portion 134 can then be pushed, separating the sliding shaft 133 of the polarity-switching mechanism 130 from the latch 140. At this point, the polarity-switching mechanism 130 hinges automatically upward by resilience of the latch 140, forcing the second magnetic portion 131 to again face the first magnetic portion 121 of the lid body 120. Therefore, the lid body 120 rotates to the first position I again by attraction between the second magnetic portion 131 and the first magnetic portion 121, as shown in FIG. 1A. Accordingly, by repeated activation of the push portion 134, the lid body 120 opens and closes repeatedly.

Moreover, the first magnetic portion 121, second magnetic portion 131, and third magnetic portion 132 may be magnets. Alternatively, the first magnetic portion 121 may be a coil capable of providing polarity when applied with current, achieving the same effect of said attraction and repulsion.

### Second Embodiment

Elements corresponding to those in the first embodiment share the same reference numerals.

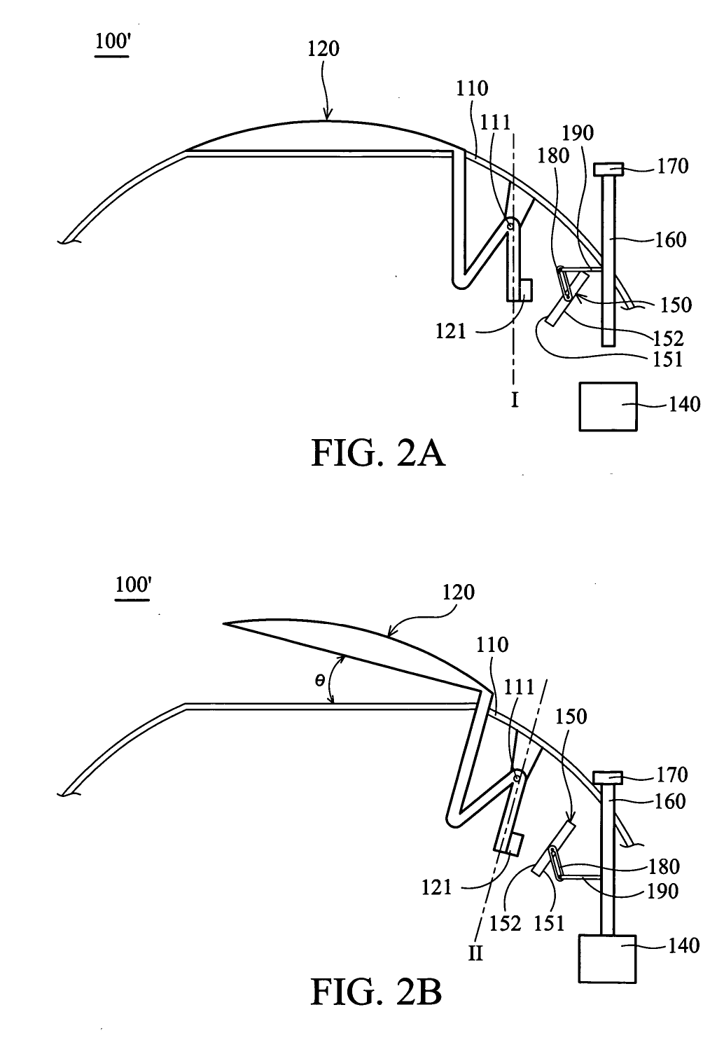

Referring to FIG. 2A and FIG. 2B, the switch 100′ comprises a casing 110, a lid body 120, a latch 140, a polarity-switching mechanism 150, a sliding shaft 160, a push portion 170, a guide member 180, and a guide bar 190.

Similarly, the casing 110 can be a housing of an optical disk drive and comprises a hinge 111. The lid body 120 is rotatably connected to the casing 110 and comprises a first magnetic portion 121. The lid body 120 can be a lid of the optical disk drive. The lid body 120 pivots on the hinge 111 of the casing 110, such that the lid body 120 can rotate with respect to the casing 110.

The polarity-switching mechanism 150 is rotatably disposed in the casing 110 and separated from the first magnetic portion 121 of the lid body 120. The polarity-switching mechanism 150 comprises a second magnetic portion 151 and a third magnetic portion 152 opposite thereto. Specifically, the polarity of the second magnetic portion 151 differs from that of the first magnetic portion 121 of the lid body 120, and the polarity of the third magnetic portion 152 is the same as that of the first magnetic portion 121.

The sliding shaft 160 is slidably disposed in the casing 110. The push portion 170 is connected to the sliding shaft 160. The guide member 180 is fixed to the polarity-switching mechanism 150. The guide bar 190 is connected to the sliding shaft 160 and slides in the guide member 180. When the sliding shaft 160 slides in the casing 110, the guide bar 190 slides with the sliding shaft 160 and in the guide member 180, thereby rotating the guide member 180. The polarity-switching mechanism 150 fixed to the guide member 180 rotates as well.

The latch 140 is disposed in the casing 110 and may comprise springs. Similarly, the latch 140 can be provided with a conventional structure.

The following description is directed to operation of the switch 100′ (or opening and closing of the lid of the optical disk drive).

When the sliding shaft 160 slides to rotate the polarity-switching mechanism 150 until the second magnetic portion 151 faces the first magnetic portion 121 of the lid body 120, the lid body 120 rotates to a first position I by attraction between the second magnetic portion 151 and the first magnetic portion 121 (as the polarity of the second magnetic portion 151 differs from that of the first magnetic portion 121), as shown in FIG. 2A. At this point, the lid body 120 abuts the casing 110. Namely, the lid of the optical disk drive is closed.

The sliding shaft 160 can slide downward by activating the push portion 170. The polarity-switching mechanism 150 rotates counterclockwise until the third magnetic portion 152 faces the first magnetic portion 121 of the lid body 120. The lid body 120 rotates to a second position II by repulsion between the third magnetic portion 152 and the first magnetic portion 121 (as the polarity of the third magnetic portion 152 is the same as that of the first magnetic portion 121), as shown in FIG. 2B. At this point, the lid body 120 separates from the casing 110. Namely, the lid of the optical disk drive is opened. Additionally, the sliding shaft 160 can be positioned in the latch 140, maintaining the rotating position of the polarity-switching mechanism 150.

Then, the push portion 170 can be pushed again, separating the sliding shaft 160 from the latch 140. At this point, the sliding shaft 160 hinges automatically upward by resilience of the latch 140, rotating the polarity-switching mechanism 150 clockwise. The second magnetic portion 151 of the polarity-switching mechanism 150 again faces the first magnetic portion 121 of the lid body 120. The lid body 120 can rotate to the first position I again by attraction between the second magnetic portion 151 and the first magnetic portion 121, as shown in FIG. 2A. Accordingly, by repeated activation of the push portion 170, the lid body 120 opens and closes repeatedly.

Similarly, the first magnetic portion 121, second magnetic portion 151, and third magnetic portion 152 may be magnets. Alternatively, the first magnetic portion 121 may be a coil capable of providing polarity when applied with current, achieving the same effect of attraction and repulsion. Specifically, the polarity-switching mechanism 150 may simply be a magnet, with the second magnetic portion 151 and third magnetic portion 152 being two opposite poles thereof.

Moreover, in the aforementioned embodiments, the lid body 120 may tightly pivots on the hinge 111. Namely, friction is increased between the lid body 120 and the hinge 111, such that delayed rotation of the lid body 120 can be obtained.

Moreover, as shown in FIG. 1B and FIG. 2B, to obtain the best performance of the switches 100, 100′ (or optical disk drives), magnetic forces provided by the first magnetic portion 121, second magnetic portions 131, 151 and third magnetic portions 132, 152, the distance between the first magnetic portion 121 and the second magnetic portion 131 or 151 (or the distance between the first magnetic portion 121 and the third magnetic portion 132 or 152), the length of the moment arm from the first magnetic portion 121 to the hinge 111, and an angle θ by which the lid body 120 rotates with respect to the casing 110 can be mutually matched and adjusted.

In conclusion, the open and close of the disclosed switches can be achieved with simplified structure, accomplished simply by activation of a push button (the push portion). Further, the disclosed switches can operate without electricity, reducing the complexity of design and manufacture.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A switch, comprising:
a casing;
a lid body rotatably connected to the casing and comprising a first magnetic portion; and
a polarity-switching mechanism disposed in the casing and separated from the first magnetic portion, wherein the lid body rotates to a first position by attraction between the polarity-switching mechanism and the first magnetic portion when the polarity of the polarity-switching mechanism differs from that of the first magnetic portion, and the lid body rotates to a second position by repulsion between the polarity-switching mechanism and the first magnetic portion when the polarity of the polarity-switching mechanism is the same as that of the first magnetic portion.

2. The switch as claimed in claim 1, wherein the polarity-switching mechanism is slidably disposed in the casing and comprises a second magnetic portion and a third magnetic portion separated therefrom by a predetermined distance, the polarity of the second magnetic portion differs from that of the first magnetic portion, the polarity of the third magnetic portion is the same as that of the first magnetic portion, the lid body rotates to the first position by attraction between the first and second magnetic portions when the polarity-switching mechanism slides to allow the second magnetic portion to face the first magnetic portion, and the lid body rotates to the second position by repulsion between the first and third magnetic portions when the polarity-switching mechanism slides to allow the third magnetic portion to face the first magnetic portion.

3. The switch as claimed in claim 2, further comprising a latch disposed in the casing, wherein the polarity-switching mechanism is positioned in the latch when the polarity-switching mechanism slides to allow the third magnetic portion to face the first magnetic portion, and the polarity-switching mechanism is separated from the latch when the polarity-switching mechanism slides to allow the second magnetic portion to face the first magnetic portion.

4. The switch as claimed in claim 3, wherein the polarity-switching mechanism further comprises a sliding shaft and a push portion, the second and third magnetic portions are disposed on the sliding shaft, the push portion is connected to the sliding shaft, and the polarity-switching mechanism is positioned in the latch by the sliding shaft.

5. The switch as claimed in claim 2, wherein the first magnetic portion is a magnet.

6. The switch as claimed in claim 2, wherein the first magnetic portion is a coil capable of providing polarity when applied with current.

7. The switch as claimed in claim 2, wherein the second and third magnetic portions are magnets.

8. The switch as claimed in claim 1, wherein the polarity-switching mechanism is rotatably disposed in the casing and comprises a second magnetic portion and a third magnetic portion opposite thereto, the polarity of the second magnetic portion differs from that of the first magnetic portion, the polarity of the third magnetic portion is the same as that of the first magnetic portion, the lid body rotates to the first position by attraction between the first and second magnetic portions when the polarity-switching mechanism rotates to allow the second magnetic portion to face the first magnetic portion, and the lid body rotates to the second position by repulsion between the first and third magnetic portions when the polarity-switching mechanism rotates to allow the third magnetic portion to face the first magnetic portion.

9. The switch as claimed in claim 8, further comprising a sliding shaft and a push portion connected thereto, wherein the sliding shaft is connected to the polarity-switching mechanism and slidably disposed in the casing, and the polarity-switching mechanism rotates by sliding of the sliding shaft, allowing the second or third magnetic portion to face the first magnetic portion.

10. The switch as claimed in claim 9, further comprising a latch disposed in the casing, wherein the sliding shaft is positioned in the latch when sliding to allow the third magnetic portion of the polarity-switching mechanism to face the first magnetic portion, and the sliding shaft is separated from the latch when sliding to allow the second magnetic portion of the polarity-switching mechanism to face the first magnetic portion.

11. The switch as claimed in claim 9, further comprising a guide member and a guide bar, wherein the guide member is fixed to the polarity-switching mechanism, the guide bar is connected to the sliding shaft and slides in the guide member, and the polarity-switching mechanism rotates by the guide bar sliding in the guide member.

12. The switch as claimed in claim 8, wherein the second and third magnetic portions are magnets.

13. The switch as claimed in claim 8, wherein the polarity-switching mechanism is a magnet, with the second and third magnetic portions being two opposite poles thereof.

14. The switch as claimed in claim 8, wherein the first magnetic portion is a magnet.

15. The switch as claimed in claim 8, wherein the first magnetic portion is a coil capable of providing polarity when applied with current.

16. The switch as claimed in claim 1, wherein the casing further comprises a hinge on which the lid body pivots.

17. The switch as claimed in claim 16, wherein the lid body tightly pivots on the hinge.

18. A switch, comprising:
a casing;
a lid body rotatably connected to the casing and comprising a first magnetic portion; and
a polarity-switching mechanism slidably disposed in the casing and separated from the first magnetic portion, wherein the polarity-switching mechanism comprises a second magnetic portion and a third magnetic portion separated therefrom by a predetermined distance, the polarity of the second magnetic portion differs from that of the first magnetic portion, the polarity of the third magnetic portion is the same as that of the first magnetic portion, the lid body rotates to a first position by attraction between the first and second magnetic portions when the polarity-switching mechanism slides to allow the second magnetic portion to face the first magnetic portion, and the lid body rotates to a second position by repulsion between the first and third magnetic portions when the polarity-switching mechanism slides to allow the third magnetic portion to face the first magnetic portion.

19. The switch as claimed in claim 18, further comprising a latch disposed in the casing, wherein the polarity-switching mechanism is positioned in the latch when the polarity-switching mechanism slides to allow the third magnetic portion to face the first magnetic portion, and the polarity-switching mechanism is separated from the latch when the polarity-switching mechanism slides to allow the second magnetic portion to face the first magnetic portion.

20. The switch as claimed in claim 19, wherein the polarity-switching mechanism further comprises a sliding shaft and a push portion, the second and third magnetic portions are disposed on the sliding shaft, the push portion is connected to the sliding shaft, and the polarity-switching mechanism is positioned in the latch by the sliding shaft.

21. The switch as claimed in claim 18, wherein the first magnetic portion is a magnet.

22. The switch as claimed in claim 18, wherein the first magnetic portion is a coil capable of providing polarity when applied with an electric current.

23. The switch as claimed in claim 18, wherein the second and third magnetic portions are magnets.

24. The switch as claimed in claim 18, wherein the casing further comprises a hinge on which the lid body pivots.

25. The switch as claimed in claim 24, wherein the lid body tightly pivots on the hinge.

26. A switch, comprising:
a casing;
a lid body rotatably connected to the casing and comprising a first magnetic portion; and
a polarity-switching mechanism rotatably disposed in the casing and separated from the first magnetic portion, wherein the polarity-switching mechanism comprises a second magnetic portion and a third magnetic portion opposite thereto, the polarity of the second magnetic portion differs from that of the first magnetic portion, the polarity of the third magnetic portion is the same as that of the first magnetic portion, the lid body rotates to a first position by attraction between the first and second magnetic portions when the polarity-switching mechanism rotates to allow the second magnetic portion to face the first magnetic portion, and the lid body rotates to a second position by repulsion between the first and third magnetic portions when the polarity-switching mechanism rotates to allow the third magnetic portion to face the first magnetic portion.

27. The switch as claimed in claim 26, further comprising a sliding shaft and a push portion connected thereto, wherein the sliding shaft is connected to the polarity-switching mechanism and slidably disposed in the casing, and the polarity-switching mechanism rotates by sliding of the sliding shaft, allowing the second or third magnetic portion to face the first magnetic portion.

28. The switch as claimed in claim 27, further comprising a latch disposed in the casing, wherein the sliding shaft is positioned in the latch when sliding to allow the third magnetic portion of the polarity-switching mechanism to face the first magnetic portion, and the sliding shaft is separated from the latch when sliding to allow the second magnetic portion of the polarity-switching mechanism to face the first magnetic portion.

29. The switch as claimed in claim 27, further comprising a guide member and a guide bar, wherein the guide member is fixed to the polarity-switching mechanism, the guide bar is connected to the sliding shaft and slides in the guide member, and the polarity-switching mechanism rotates by the guide bar sliding in the guide member.

30. The switch as claimed in claim 26, wherein the second and third magnetic portions are magnets.

31. The switch as claimed in claim 26, wherein the polarity-switching mechanism is a magnet, with the second and third magnetic portions being two opposite poles thereof.

32. The switch as claimed in claim 26, wherein the first magnetic portion is a magnet.

33. The switch as claimed in claim 26, wherein the first magnetic portion is a coil capable of providing polarity when applied with current.

34. The switch as claimed in claim 26, wherein the casing further comprises a hinge on which the lid body pivots.

35. The switch as claimed in claim 34, wherein the lid body tightly pivots on the hinge.
